(19) United States
(12) Patent Application Publication
(10) Pub. No.: US 2026/0353237 A1
(43) Pub. Date: Nov. 5, 2026

(54) METHOD AND APPARATUS FOR CONDITIONAL MOBILITY CONFIGURATION IN A WIRELESS COMMUNICATION SYSTEM

(71) Applicant: LG ELECTRONICS INC., Seoul (KR)

(72) Inventors: Sangwon KIM, Seoul (KR); Sunghoon JUNG, Seoul (KR); Hongsuk KIM, Seoul (KR)

(73) Assignee: LG ELECTRONICS INC., Seoul (KR)

(21) Appl. No.: 19/490,307

(22) PCT Filed: Jun. 11, 2024
(86) PCT No.: PCT/KR2024/007968

§ 371 Date: Dec. 4, 2025

Related U.S. Application Data
(60) Provisional application No. 63/472,567, filed on Jun. 12, 2023.

(51) Int. Cl. H04W 36/36

(52) U.S. Cl. CPC H04W 36/362

(57) ABSTRACT

A method and apparatus for conditional mobility configuration in a wireless communication system is provided. The method performed by a wireless device comprises: receiving information related to conditional mobility for one or more candidate PCells and one or more candidate PSCells; based on that a pair of a candidate PCell and a candidate PSCell related to the candidate PCell satisfying each execution condition for the conditional mobility exists:—performing the conditional mobility for the candidate PCell and the candidate PSCell; and based on that a pair of a candidate PCell and a candidate PSCell related to the candidate PCell satisfying each execution condition for the conditional mobility does not exist:—performing the conditional mobility for a candidate PCell or a candidate PSCell which fulfills an execution condition.

### CROSS-REFERENCE TO RELATED APPLICATION(S)

This application is the National Stage filing under 35 U.S.C. 371 of International Application No. PCT/KR2024/007968, filed on Jun. 11, 2024, which claims the benefit of U.S. Provisional Application No. 63/472,567, filed on Jun. 12, 2023, the contents of which are all incorporated by reference herein in their entirety.

### TECHNICAL FIELD

The present disclosure relates to a method and apparatus for conditional mobility configuration in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

The conditional handover configuration may include a conditional Primary Secondary Cell Group (SCG) Cell (PSCell) addition/change (=conditional handover (CHO) including conditional PSCell addition or change (CPAC)). The execution condition for CHO including CPAC consists of an execution condition associated with candidate Primary Cell (PCell) and an execution condition associated with candidate PSCell. If the CHO including CPC is configured, the UE execute the conditional handover when the execution condition for CHO including CPAC is met, that is, when both the execution condition associated with candidate PCell and the execution condition associated with the candidate PSCell are met.

For a candidate PCell, UE can be configured with both CHO without CPAC (i.e. conditional handover configuration not including conditional PSCell addition/change) and CHO including CPAC. If the execution condition for CHO without CPAC and the execution condition for CHO including CPAC are met simultaneously, the UE may execute CHO without CPAC.

The CHO without CPAC may or may not include secondary cell group (SCG) configuration. If the CHO without CPAC include SCG configuration, since the SCG is blindly added upon conditional handover, the quality of the SCG is not guaranteed. If the CHO without CPAC doesn't include the SCG configuration, the UE cannot use SCG upon conditional handover. Therefore, if the execution condition for CHO without CPAC and the execution condition for CHO including CPAC are met simultaneously, it is better for UE to execute CHO including CPAC so that the UE can add a qualified SCG upon conditional handover.

Therefore, studies for conditional mobility configuration in a wireless communication system are required.

In an aspect, a method performed by a wireless device in a wireless communication system is provided. The method comprises: receiving information related to conditional mobility for one or more candidate Primary Cells (PCells) and one or more candidate Primary Secondary Cell Group (SCG) Cells (PSCells); based on that a pair of a candidate PCell and a candidate PSCell related to the candidate PCell satisfying each execution condition for the conditional mobility exists:—performing the conditional mobility for the candidate PCell and the candidate PSCell; and based on that a pair of a candidate PCell and a candidate PSCell related to the candidate PCell satisfying each execution condition for the conditional mobility does not exist:—performing the conditional mobility for a candidate PCell or a candidate PSCell which fulfills an execution condition.

In another aspect, an apparatus for implementing the above method is provided.

The present disclosure can have various advantageous effects.

According to some embodiments of the present disclosure, the wireless device could efficiently handle the conditional mobility configuration by prioritizing the CHO with CPAC over the CHO without CPAC.

For example, the wireless device can use qualified SCG upon conditional handover by applying an SCG which satisfies the execution condition.

In other words, if the execution condition is satisfied, the conditional mobility can be performed using the SCG configuration.

According to some embodiments of the present disclosure, the wireless communication system could provide an efficient solution for handling the conditional mobility configuration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of measurement reporting to which implementations of the present disclosure is applied.

FIGS. 11a, 11b, and 11c show an example of a conditional SN change procedure initiated by SN.

FIG. 12 shows an example of a method for conditional mobility configuration in a wireless communication system, according to some embodiments of the present disclosure.

FIG. 13 shows an example for prioritization of conditional mobility configuration according to some embodiments of the present disclosure.

FIG. 14 shows an example for prioritizing conditional mobility configuration according to some embodiments of the present disclosure.

FIG. 15 shows an example for handling conditional mobility configuration according to some embodiments of the present disclosure.

FIG. 16 shows an example of ConditionalReconfiguration information element.

FIG. 17 shows an example of CondReconfigToAddModList information element.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

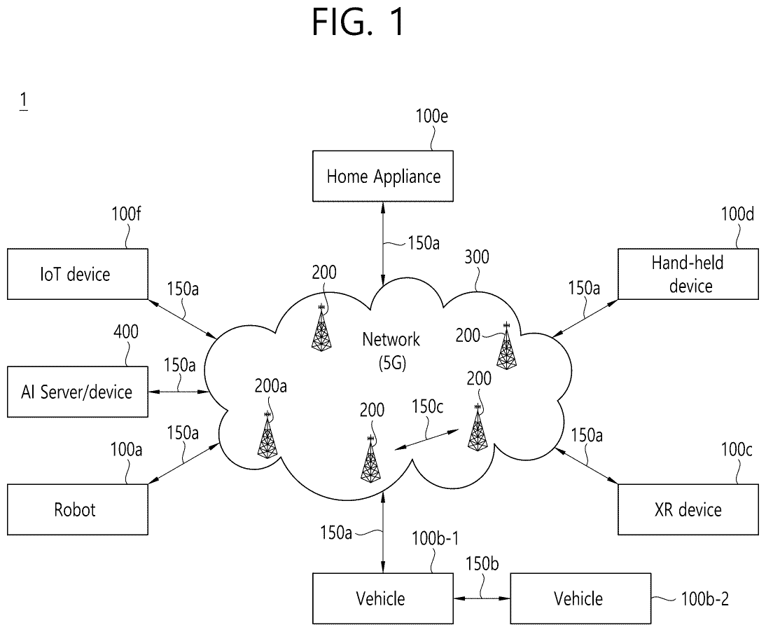

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

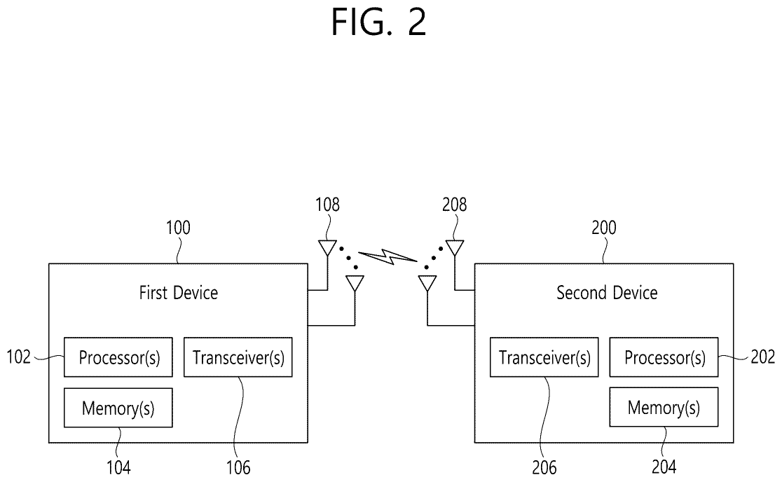

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

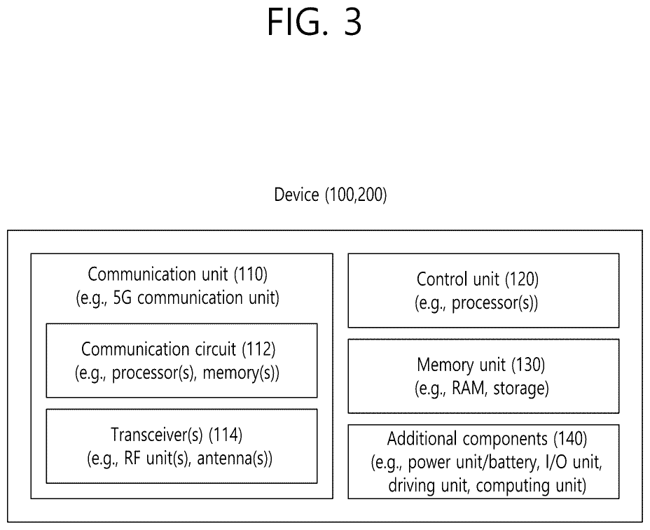

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

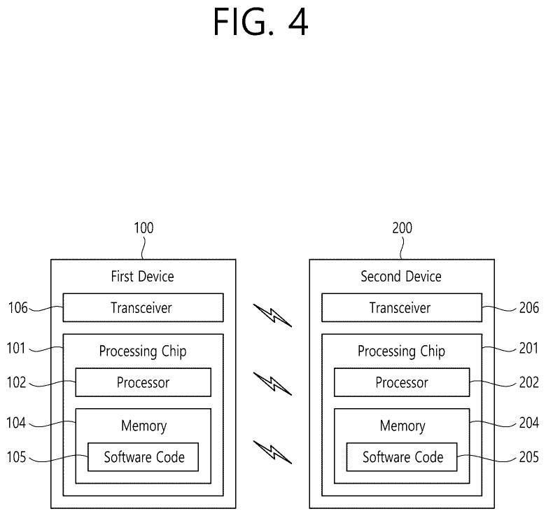

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

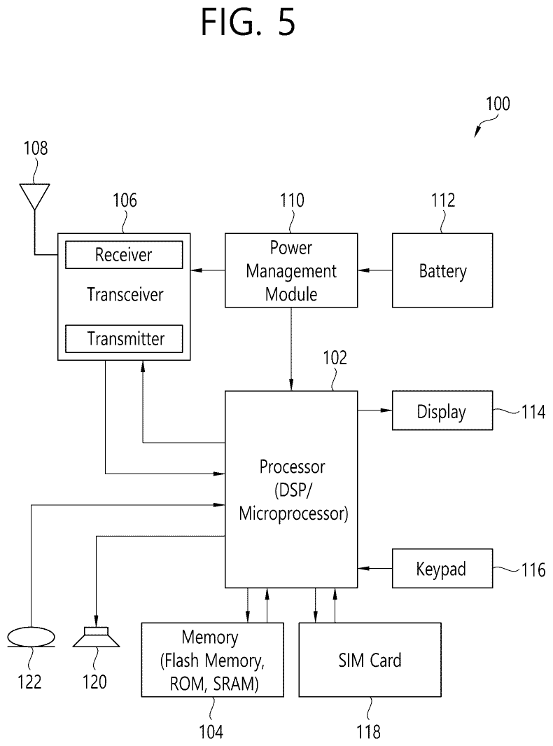

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

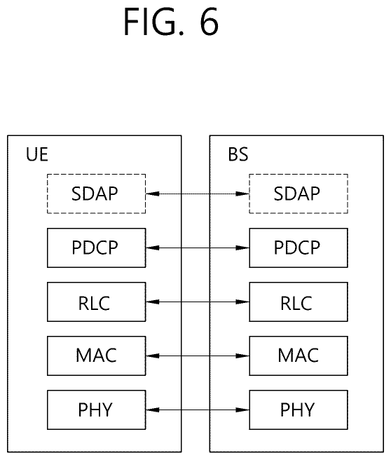

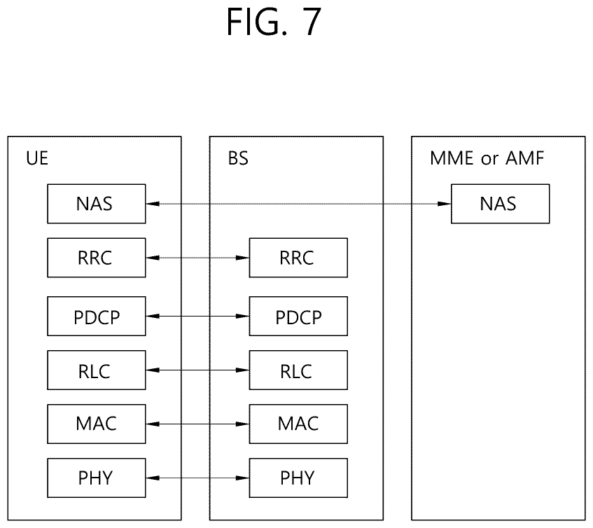

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

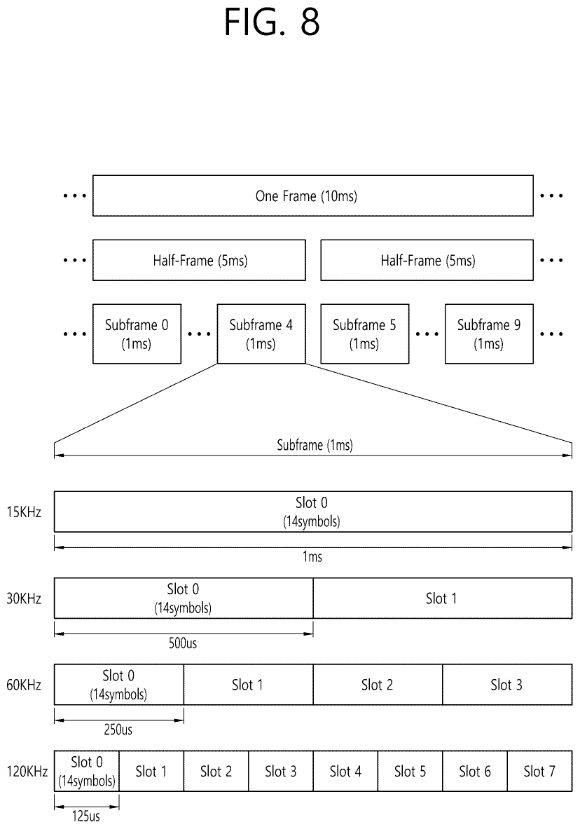

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{μ}*15 kHz.

Table 1 shows the number of OFDM symbols per slot N^{slots}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | Subcarrier | |
|---|---|---|---|
| designation | frequency range | Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

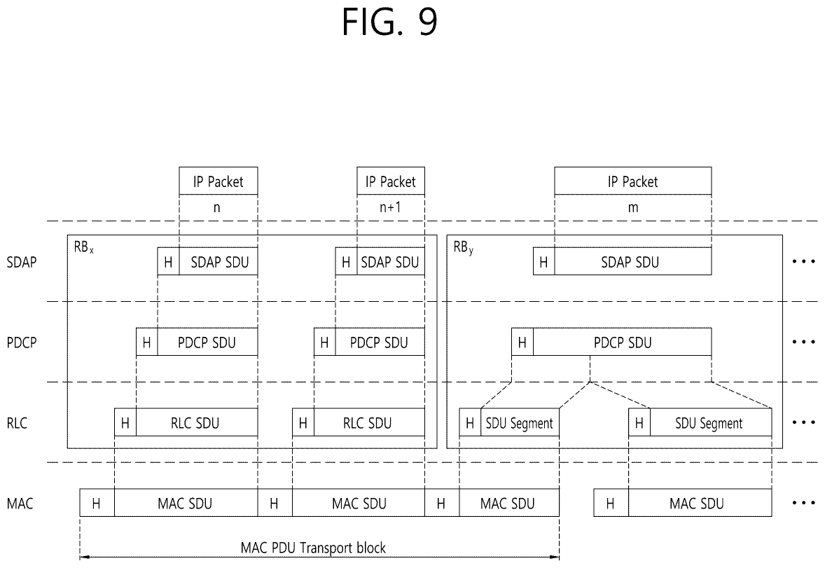

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to measurements are described. Section 5.5 of 3GPP TS 38.331 v17.2.0 may be referred.

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.

The network may configure the UE to perform the following types of measurements:
NR measurements;
Inter-RAT measurements of E-UTRA frequencies;
Inter-RAT measurements of UTRA-FDD frequencies;
NR sidelink measurements of L2 U2N Relay UEs.

The network may configure the UE to report the following measurement information based on SS/PBCH block(s):
Measurement results per SS/PBCH block;
Measurement results per cell based on SS/PBCH block(s);
SS/PBCH block(s) indexes.

The network may configure the UE to report the following measurement information based on CSI-RS resources:
Measurement results per CSI-RS resource;
Measurement results per cell based on CSI-RS resource(s);
CSI-RS resource measurement identifiers.

The network may configure the UE to perform the following types of measurements for NR sidelink and V2X sidelink:
CBR measurements.

The network may configure the UE to report the following CLI measurement information based on SRS resources:
Measurement results per SRS resource;
SRS resource(s) indexes.

The network may configure the UE to report the following CLI measurement information based on CLI-RSSI resources:
Measurement results per CLI-RSSI resource;
CLI-RSSI resource(s) indexes.

The network may configure the UE to report the following Rx-Tx time difference measurement information based on CSI-RS for tracking or PRS:
UE Rx-Tx time difference measurement result.

The measurement configuration includes the following parameters:

1. Measurement objects: A list of objects on which the UE shall perform the measurements.
For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
The measObjectId of the MO which corresponds to each serving cell is indicated by servingCellMO within the serving cell configuration.
For inter-RATE-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
For inter-RAT UTRA-FDD measurements a measurement object is a set of cells on a single UTRA-FDD carrier frequency.
For NR sidelink measurements of L2 U2N Relay UEs, a measurement object is a single NR sidelink frequency to be measured.
For CBR measurement of NR sidelink communication, a measurement object is a set of transmission resource pool(s) on a single carrier frequency for NR sidelink communication.
For CBR measurement of NR sidelink discovery, a measurement object is a set of discovery dedicated resource pool(s) or transmission resource pool(s) also used for NR sidelink discovery on a single carrier frequency for NR sidelink discovery.
For CLI measurements a measurement object indicates the frequency/time location of SRS resources and/or CLI-RSSI resources, and subcarrier spacing of SRS resources to be measured.

2. Reporting configurations: A list of reporting configurations where there can be one or multiple reporting configurations per measurement object. Each measurement reporting configuration consists of the following:
Reporting criterion: The criterion that triggers the UE to send a measurement report. This can either be periodical or a single event description.
RS type: The RS that the UE uses for beam and cell measurement results (SS/PBCH block or CSI-RS).
Reporting format: The quantities per cell and per beam that the UE includes in the measurement report (e.g. RSRP) and other associated information such as the maximum number of cells and the maximum number beams per cell to report.

In case of conditional reconfiguration, each configuration consists of the following:
Execution criteria: The criteria the UE uses for conditional reconfiguration execution.
RS type: The RS that the UE uses for obtaining beam and cell measurement results (SS/PBCH block-based or CSI-RS-based), used for evaluating conditional reconfiguration execution condition.

3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

5. Measurement gaps: Periods that the UE may use to perform measurements.

A UE in RRC CONNECTED maintains a measurement object list, a reporting configuration list, and a measurement identities list according to signalling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells:
1. The NR serving cell(s)—these are the SpCell and one or more SCells.
2. Listed cells—these are cells listed within the measurement object(s).
3. Detected cells—these are cells that are not listed within the measurement object(s) but are detected by the UE on the SSB frequency(ies) and subcarrier spacing(s) indicated by the measurement object(s).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources). For L2 U2N Relay object(s), the UE measures and reports on the serving NR cell(s), as well as the discovered L2 U2N Relay UEs.

Whenever the procedural specification, other than contained in clause 5.5.2, refers to a field it concerns a field included in the VarMeasConfig unless explicitly stated otherwise i.e. only the measurement configuration procedure covers the direct UE action related to the received measConfig.

In NR-DC, the UE may receive two independent measConfig:
a measConfig, associated with MCG, that is included in the RRCReconfiguration message received via SRB1; and
a measConfig, associated with SCG, that is included in the RRCReconfiguration message received via SRB3, or, alternatively, included within a RRCReconfiguration message embedded in a RRCReconfiguration message received via SRB1.

In this case, the UE maintains two independent VarMeasConfig and VarMeasReportList, one associated with each measConfig, and independently performs all the procedures in clause 5.5 for each measConfig and the associated VarMeasConfig and VarMeasReportList, unless explicitly stated otherwise.

The configurations related to CBR measurements are only included in the measConfig associated with MCG.

The configurations related to Rx-Tx time difference measurement are only included in the measConfig associated with MCG.

### Quantity Configuration

The UE shall:

1> for each RAT for which the received quantityConfig includes parameter(s):

2> set the corresponding parameter(s) in quantityConfig within VarMeasConfig to the value of the received quantityConfig parameter(s);

1> for each measId included in the measIdList within VarMeasConfig:

2> remove the measurement reporting entry for this measId from the VarMeasReportList, if included;

2> stop the periodical reporting timer or timer T321 or timer T322, whichever one is running, and reset the associated information (e.g. timeToTrigger) for this measId.

### Performing Measurements

An RRC_CONNECTED UE shall derive cell measurement results by measuring one or multiple beams associated per cell as configured by the network. For all cell measurement results, except for RSSI, and CLI measurement results in RRC_CONNECTED, the UE applies the layer 3 filtering, before using the measured results for evaluation of reporting criteria, measurement reporting or the criteria to trigger conditional reconfiguration execution. For cell measurements, the network can configure RSRP, RSRQ, SINR, RSCP or EcNO as trigger quantity. For CLI measurements, the network can configure SRS-RSRP or CLI-RSSI as trigger quantity. For cell and beam measurements, reporting quantities can be any combination of quantities (i.e. only RSRP; only RSRQ; only SINR; RSRP and RSRQ; RSRP and SINR; RSRQ and SINR; RSRP, RSRQ and SINR; only RSCP; only EcNO; RSCP and EcNO), irrespective of the trigger quantity, and for CLI measurements, reporting quantities can be either SRS-RSRP or CLI-RSSI. For conditional reconfiguration execution, the network can configure up to 2 quantities, both using same RS type. The UE does not apply the layer 3 filtering to derive the CBR measurements. The UE does not apply the layer 3 filtering to derive the Rx-Tx time difference measurements.

The network may also configure the UE to report measurement information per beam (which can either be measurement results per beam with respective beam identifier(s) or only beam identifier(s)). If beam measurement information is configured to be included in measurement reports, the UE applies the layer 3 beam filtering. On the other hand, the exact L1 filtering of beam measurements used to derive cell measurement results is implementation dependent.

Events for measurement reporting which can be applied to the present disclosure are described.

Event A1 (Serving becomes better than threshold)

Event A2 (Serving becomes worse than threshold)

Event A3 (Neighbour becomes offset better than SpCell)

Event A4 (Neighbour becomes better than threshold)

Event A5 (SpCell becomes worse than threshold1 and neighbour becomes better than threshold2)

Event A6 (Neighbour becomes offset better than SCell)

Event B1 (Inter RAT neighbour becomes better than threshold)

Event B2 (PCell becomes worse than threshold1 and inter RAT neighbour becomes better than threshold2)

Event I1 (Interference becomes higher than threshold)

Event C1 (The NR sidelink channel busy ratio is above a threshold)

Event C2 (The NR sidelink channel busy ratio is below a threshold)

CondEvent T1

Event X1 (Serving L2 U2N Relay UE becomes worse than threshold1 and NR Cell becomes better than threshold2)

Event X2 (Serving L2 U2N Relay UE becomes worse than threshold)

Event Y1 (PCell becomes worse than threshold1 and candidate L2 U2N Relay UE becomes better than threshold2)

Event Y2 (Candidate L2 U2N Relay UE becomes better than threshold)

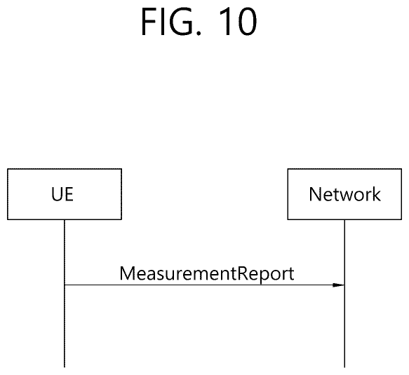

FIG. 10 shows an example of measurement reporting to which implementations of the present disclosure is applied.

The purpose of this procedure is to transfer measurement results from the UE to the network. The UE shall initiate this procedure only after successful AS security activation.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
2> if the reportConfig associated with the measId that triggered the measurement reporting includes rsType:
3> if the serving cell measurements based on the rsType included in the reportConfig that triggered the measurement report are available:
4> set the measResultServingCell within measResultServingMOList to include RSRP, RSRQ and the available SINR of the serving cell, derived based on the rsType included in the reportConfig that triggered the measurement report;
2> else:
3> if SSB based serving cell measurements are available:
4> set the measResultServingCell within measResultServingMOList to include RSRP, RSRQ and the available SINR of the serving cell, derived based on SSB;
3> else if CSI-RS based serving cell measurements are available:
4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
2> for each serving cell configured with servingCellMO, include beam measurement information according to the associated reportConfig;
1> if the reportConfig associated with the measId that triggered the measurement reporting includes reportAddNeighMeas:
2> for each measObjectId referenced in the measIdList which is also referenced with servingCellMO, other than the measObjectId corresponding with the measId that triggered the measurement reporting:
3> if the measObjectNR indicated by the servingCellMO includes the RS resource configuration corresponding to the rsType indicated in the reportConfig:
4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
4> if the reportConfig associated with the measId that triggered the measurement reporting includes reportQuantityRS-Indexes and maxNrofRS-IndexesToReport:
5> for each best non-serving cell included in the measurement report:
6> include beam measurement information according to the associated reportConfig;

Hereinafter, technical features related to conditional reconfiguration are described. Section 5.5.13 of 3GPP TS 38.331 v17.2.0 may be referred.

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

In NR-DC, the UE may receive two independent conditionalReconfiguration:
a conditionalReconfiguration associated with MCG, that is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

In this case:
the UE maintains two independent VarConditionalReconfig, one associated with each conditionalReconfiguration;
the UE independently performs all the procedures for each conditionalReconfiguration and the associated VarConditionalReconfig, unless explicitly stated otherwise;
the UE performs the procedures for the VarConditionalReconfig associated with the same cell group like the measConfig.

The UE performs the following actions based on a received ConditionalReconfiguration IE:
1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition/modification;

### Conditional Reconfiguration Evaluation

The UE shall:
1> for each condReconfigId within the VarConditionalReconfig:
2> if the RRCReconfiguration within condRRCReconfig includes the masterCellGroup including the reconfigurationWithSync:
3> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfigurationWithSync:
3> consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedure, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig, or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time ToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding time ToTrigger defined for this event within the VarConditionalReconfig, or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time ToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution;

Up to 2 MeasId can be configured for each condReconfigId. The conditional reconfiguration event of the 2 MeasId may have the same or different event conditions, triggering quantity, time to trigger, and triggering threshold.

### Conditional Reconfiguration Evaluation of SN Initiated Inter-SN CPC for EN-DC

The UE shall:
1> for each condReconfigurationId within the VarConditionalReconfiguration:
2> for each measId included in the measIdList within VarMeasConfig indicated in the CondReconfigExecCondSCG contained in the triggerConditionSN associated to the condReconfigurationId:
3> if the entry condition(s) applicable for the event associated with that measId, is fulfilled for the applicable cells for all measurements after layer 3 filtering taken during the corresponding time ToTrigger defined for this event associated with that measId:
4> consider this event to be fulfilled;
3> if the measId for this event has been modified; or
3> if the leaving condition(s) applicable for this event associated with that measId, is fulfilled for the applicable cells for all measurements after layer 3 filtering taken during the corresponding time ToTrigger defined for this event associated with that measId:
4> consider this event associated to that measId to be not fulfilled;
2> if trigger conditions for all events associated with the measId(s) indicated in the CondReconfigExecCondSCG contained in the triggerConditionSN, are fulfilled:
3> consider the target cell candidate within the RRCReconfiguration message contained in nr-SecondaryCellGroupConfig in the RRCConnectionReconfiguration message, contained in the stored condReconfigurationToApply, associated to that condReconfigurationId, as a triggered cell;
3> initiate the conditional reconfiguration execution;

### Conditional Reconfiguration Execution

The UE shall:
1> if more than one triggered cell exists:
2> select one of the triggered cells as the selected cell for conditional reconfiguration execution;
1> else:
2> consider the triggered cell as the selected cell for conditional reconfiguration execution;
1> for the selected cell of conditional reconfiguration execution:
2> apply the stored condRRCReconfig of the selected cell and perform the actions;

If multiple NR cells are triggered in conditional reconfiguration execution, it is up to UE implementation which one to select, e.g. the UE considers beams and beam quality to select one of the triggered cells for execution.

### SCG Activation

Upon initiating the procedure, the UE shall:
1> if the UE is configured with an SCG after receiving the message for which this procedure is initiated:
2> if the UE was configured with a deactivated SCG before receiving the message for which this procedure is initiated:
3> consider the SCG to be activated;
3> resume performing radio link monitoring on the SCG, if previously stopped;
3> indicate to lower layers to resume beam failure detection on the PSCell, if previously stopped;
3> indicate to lower layers that the SCG is activated.

### SCG Deactivation

Upon initiating the procedure, the UE shall:
1> consider the SCG to be deactivated;
1> indicate to lower layers that the SCG is deactivated;
1> if bfd-and-RLM is configured to true:
2> perform radio link monitoring on the SCG;
2> indicate to lower layers to perform beam failure detection on the PSCell;
1> else:
2> stop radio link monitoring on the SCG;
2> indicate to lower layers to stop beam failure detection on the PSCell;
2> stop timer T310 for this cell group, if running;
2> stop timer T312 for this cell group, if running;
2> reset the counters N310 and N311;
1> if the UE was in RRC_CONNECTED and the SCG was activated before receiving the message for which this procedure is initiated:
2> if SRB3 was configured before the reception of the RRCReconfiguration or of the RRCConnectionReconfiguration and SRB3 is not to be released according to any RadioBearerConfig included in the RRCReconfiguration or in the RRCConnectionReconfiguration:
3> trigger the PDCP entity of SRB3 to perform SDU discard;
3> re-establish the RLC entity of SRB3.
   SCG Activation without SN Message

Upon initiating the procedure, the UE shall:
1> if the SCG was deactivated before the reception of the RRCReconfiguration message or the E-UTRA RRCConnectionReconfiguration message for which the procedure invoking this clause is executed:
2> consider the SCG to be activated;
2> indicate to lower layers that the SCG is activated;
2> resume performing radio link monitoring on the SCG, if previously stopped;
2> indicate to lower layers to resume beam failure detection on the PSCell, if previously stopped;
2> if bfd-and-RLM was not configured to true before the reception of the RRCReconfiguration message or the E-UTRA RRCConnectionReconfiguration message for which the procedure invoking this clause is executed; or
2> if lower layers indicate that a Random Access procedure is needed for SCG activation:
3> initiate the Random Access procedure on the PSCell.

Hereinafter, technical features related to SN initiated conditional SN Change are described. 3GPP TS 37.340 v17.3.0 may be referred.

The SN initiated conditional SN change procedure is used for CPC configuration and CPC execution.

The SN initiated conditional SN change procedure may also be initiated by the source SN, to modify the existing CPC configuration, or to trigger the release of the candidate SN by cancellation of all the prepared PSCells at the candidate SN and releasing the CPC related UE context at the candidate SN.

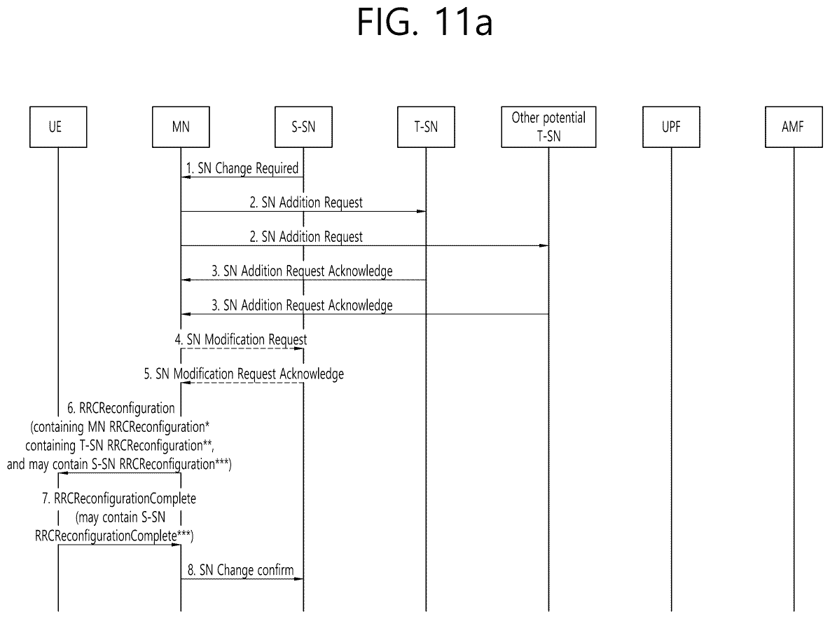

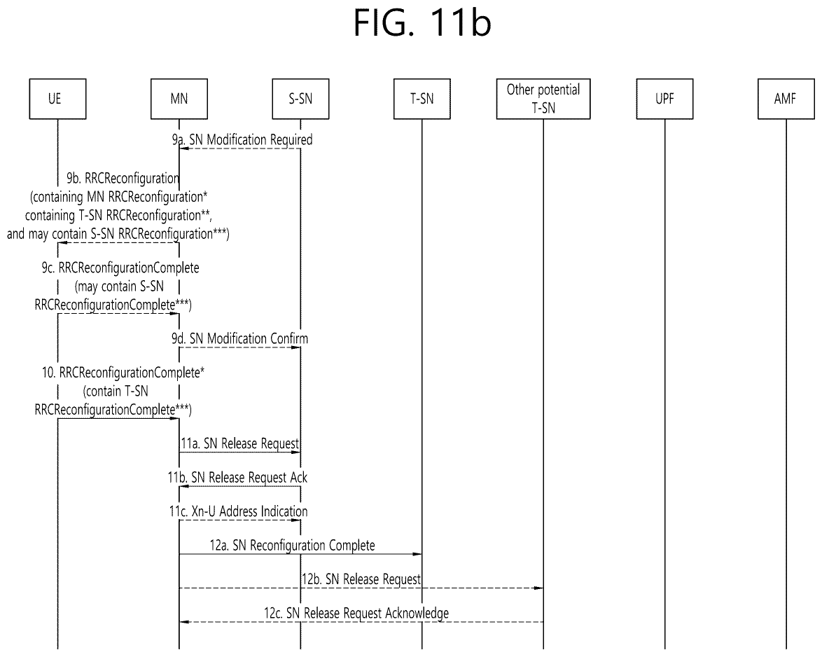

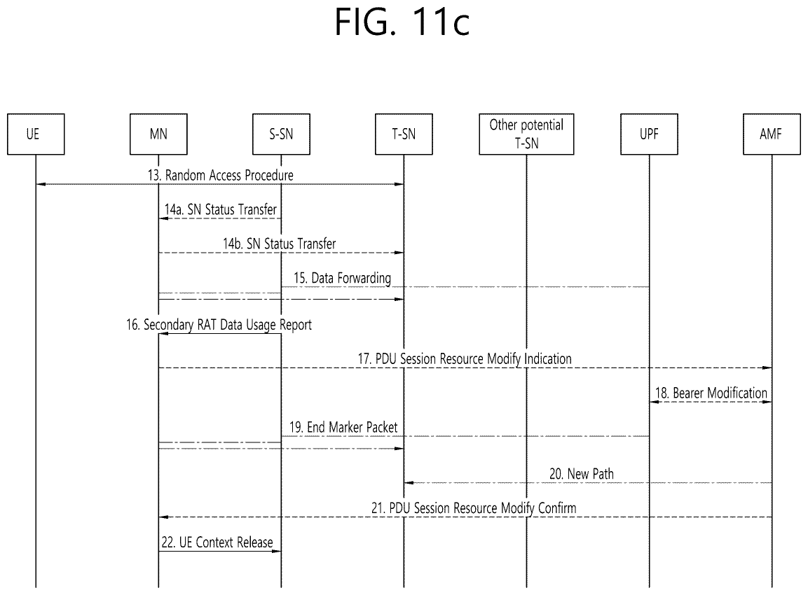

FIGS. 11a, 11b, and 11c show an example of a conditional SN change procedure initiated by SN.

In particular, FIGS. 11a, 11b, and 11c illustrate an example of signalling flow for the conditional SN Change initiated by the SN:
1. The source SN initiates the conditional SN change procedure by sending the SN Change Required message, which contains a CPC initiation indication. The message also contains candidate node ID(s) and may include the SCG configuration (to support delta configuration), and contains the measurements results which may include cells that are not CPC candidates. The message also includes a list of proposed PSCell candidates recommended by the source SN, including execution conditions, the upper limit for the number of PSCells that can be prepared by each candidate SN, and may also include the SCG measurement configurations for CPC (e.g. measurement ID(s) to be used for CPC).
2/3. The MN requests each candidate SN(s) to allocate resources for the UE by means of the SN Addition procedure(s), indicating the request is for CPAC, and the measurements results which may include cells that are not CPC candidates received from the source SN to the candidate SN, and indicating a list of proposed PSCell candidates received from the source SN, but not including execution conditions. Within the list of PSCells suggested by the source SN, the candidate SN decides the list of PSCell(s) to prepare (considering the maximum number indicated by the MN) and, for each prepared PSCell, the candidate SN decides SCG SCells and provides the new corresponding SCG radio resource configuration to the MN in an NR RRCReconfiguration** message contained in the SgNB Addition Request Acknowledge message. If data forwarding is needed, the candidate SN provides data forwarding addresses to the MN. The candidate SN includes the indication of full or delta RRC configuration, and the list of prepared PSCell IDs to the MN. The candidate SN can either accept or reject each of the candidate cells suggested by the source SN, i.e., it cannot configure any alternative candidates.
4/5. The MN may indicate the candidate PSCells accepted by each candidate SN to the source SN via SN Modification Request message before it configures the UE, e.g., when not all candidate PSCells were accepted by the candidate SN(s). If the MN does not send such indication, step 4 and 5 are skipped. If requested, the source SN sends an SN Modification Request Acknowledge message and if needed, provides an updated measurement configurations and/or the execution conditions to the MN.
6. The MN sends to the UE an RRCReconfiguration message including the CPC configuration, i.e. a list of RRCReconfiguration* messages and associated execution conditions, in which each RRCReconfiguration* message contains the SCG configuration in the RRCReconfiguration** message received from the candidate SN in step 3 and possibly an MCG configuration. Besides, the RRCReconfiguration message can also include an updated MCG configuration, as well as the NR RRCReconfiguration** message generated by the source SN, e.g., to configure the required conditional measurements.
7. The UE applies the RRCReconfiguration message received in step 6, stores the CPC configuration and replies to the MN with an RRCReconfigurationComplete message, which can include an NR RRCReconfigurationComplete*** message. In case the UE is unable to comply with (part of) the configuration included in the RRCReconfiguration message, it performs the reconfiguration failure procedure.
8. If an SN RRC response message is included, the MN informs the source SN with the SN RRCReconfigurationComplete*** message via SN Change Confirm message. If step 4 and 5 are skipped, the MN will indicate the candidate PSCells accepted by each candidate SN to the source SN in the SN Change Confirm message.

The MN sends the SN Change Confirm message towards the source SN to indicate that CPC is prepared, and in such case the source SN continues providing user data to the UE. If early data forwarding is applied, the MN informs the source SN the data forwarding addresses as received from the candidate SN(s), the source SN, if applicable, together with the Early Status Transfer procedure, starts early data forwarding. The PDCP SDU forwarding may take place during early data forwarding. In case multiple candidate SNs are prepared, the MN includes a list of Target SN ID and list of data forwarding addresses to the source SN.

For example, the Xn-U Address Indication procedure may further be invoked to indicate to the source SN to stop already initiated early data forwarding for some PDCP SDUs if they are no longer subject to data forwarding due to the modification or cancellation of the prepared conditional PSCell change.
9a-9d. The source SN may send the SN Modification Required message to trigger an update of CPC execution condition and/or corresponding SCG measurement configuration for CPC. In such case in step 9b, the MN reconfigures the UE and in step 9c the UE responds with RRCReconfigurationComplete, similarly as in steps 6 and 7.
10. The UE starts evaluating the execution conditions. If the execution condition of one candidate PSCell is satisfied, the UE applies RRCReconfiguration* message corresponding to the selected candidate PSCell, and sends an RRCReconfigurationComplete* message, including an RRCReconfigurationComplete** message for the selected candidate PSCell, and information enabling the MN to identify the SN of the selected candidate PSCell.
11a-11c. The MN triggers the MN initiated SN Release procedure to inform the source SN to stop providing user data to the UE, and triggers the Xn-U Address Indication procedure to inform the source SN the address of the SN of the selected candidate PSCell and if applicable, starts late data forwarding.
12a-12c. If the RRC connection reconfiguration procedure was successful, the MN informs the SN of the selected candidate PSCell via SN Reconfiguration Complete message, including the SN RRCReconfigurationComplete** message. The MN sends the SN Release Request message(s) to cancel CPC in the other candidate SN(s), if configured. The other candidate SN(s) acknowledges the release request.
13. The UE synchronizes to the PSCell indicated in the RRCReconfiguration* message applied in step 10.
14. If PDCP termination point is changed for bearers using RLC AM, the source SN sends the SN Status Transfer message, which the MN sends then to the SN of the selected candidate PSCell, if needed.
15. If applicable, data forwarding from the source SN takes place. It may be initiated as early as the source SN receives the data forwarding address related information from the MN.
16. The source SN sends the Secondary RAT Data Usage Report message to the MN and includes the data volumes delivered to and received from the UE.

For example, the order the SN sends the Secondary RAT Data Usage Report message and performs data forwarding with MN/target SN is not defined. The SN may send the report when the transmission of the related QoS flow is stopped.
17-21. If applicable, a PDU Session path update procedure is triggered by the MN.
22. Upon reception of the UE Context Release message, the source SN releases radio and C-plane related resources associated to the UE context. Any ongoing data forwarding may continue.

Hereinafter, technical features related to area-specific CPAC are described.

When the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

In Rel-17 Conditional PSCell change (CPC)/Conditional PSCell addition (CPA), a CPC/CPA-configured UE has to release the CPC/CPA configurations when completing random access towards the target PSCell. Hence the UE doesn't have a chance to perform subsequent CPC/CPA without prior CPC/CPA reconfiguration and re-initialization from the network. This will increase the delay for the cell change and increase the signaling overhead, especially in the case of frequent SCG changes when operating FR2. Therefore, MR-DC with selective activation of cell groups aims at enabling subsequent CPC/CPA after SCG change, without reconfiguration and re-initialization on the CPC/CPA preparation from the network. This results in a reduction of the signalling overhead and interrupting time for SCG change.

Currently, CHO and MR-DC cannot be configured simultaneously. This limits the usefulness of these two features when MR-DC is configured. If it is not completed in Rel-17, Rel-18 should specify mechanisms for CHO and MR-DC to be configured simultaneously. However, this alone may not be sufficient to optimise MR-DC mobility, as the radio link quality of the conditionally-configured PSCell may not be good enough or may not be the best candidate PSCell when the UE accesses the target PCell, and this may impact the UE throughput. To mitigate this throughput impact, Rel-18 CHO+MRDC can consider CHO including target MCG and multiple candidate SCGs for CPC/CPA.

The detailed objective related to area-specific CPAC are:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]

For example, early RAN2 involvement is necessary, including the possibility of further clarifying the interaction between this bullet with the previous bullet
Timing Advance management [RAN1, RAN2]
CU-DU interface signaling to support L1/L2 mobility, if needed [RAN3]

For example, FR2 specific enhancements are not precluded, if any.

For example, the procedure of L1/L2 based inter-cell mobility are applicable to the following scenarios:
Standalone, CA and NR-DC case with serving cell change within one CG
Intra-DU case and intra-CU inter-DU case (applicable for Standalone and CA: no new RAN interfaces are expected)
Both intra-frequency and inter-frequency
Both FR1 and FR2
Source and target cells may be synchronized or non-synchronized
2. To specify mechanism and procedures of NR-DC with selective activation of the cell groups (at least for SCG) via L3 enhancements:
   To allow subsequent cell group change after changing CG without reconfiguration and re-initiation of CPC/CPA [RAN2, RAN3, RAN4]

For example, a harmonized RRC modelling approach for objectives 1 and 2 could be considered to minimize the workload in RAN2.
3. For CHO including target MCG and target SCG in NR-DC [RAN3]:
   to specify data forwarding optimizations; and
   to specify, if needed, a solution to avoid unnecessary signaling exchange between source MN and target SN.
4. To specify CHO including target MCG and candidate SCGs for CPC/CPA in NR-DC [RAN3, RAN2]
   CHO including target MCG and target SCG is used as the baseline
5. To specify RRM core requirements for the following, as necessary [RAN4]:
   L1/L2-based inter-cell mobility
   Enhanced CHO configurations addressed by this WI
6. To specify RF requirements to cover inter-frequency L1/L2-based mobility, as necessary [RAN4].
7. To study and specify how to reuse the IDLE/INACTIVE mode measurement results which are to be reported during and/or after RRC connection setup/resume in order to improve SCell/SCG setup delay [RAN4, RAN2], including:
   Availability and validation of the IDLE/INACTIVE mode measurement results to be reported [RAN4]; and
   Definition of corresponding RRM requirements [RAN4]; and
   If necessary based on RAN4 outcome, definition of corresponding signalling support [RAN2].

For example, RAN4 will coordinate in due course with RAN2 to start the work.

For example, with exception of the above scenarios, enhancements on IDLE/INACTIVE mode measurements and on UE behavior in IDLE/INACTIVE mode are not in scope.

Meanwhile, the conditional handover configuration may include a conditional PSCell addition/change (=CHO including CPAC). The execution condition for CHO including CPAC consists of an execution condition associated with candidate PCell and an execution condition associated with candidate PSCell. If the CHO including CPC is configured, the UE execute the conditional handover when the execution condition for CHO including CPAC is met, that is, when both the execution condition associated with candidate PCell and the execution condition associated with the candidate PSCell are met.

For a candidate PCell, UE can be configured with both CHO without CPAC (i.e. conditional handover configuration not including conditional PSCell addition/change) and CHO including CPAC. If the execution condition for CHO without CPAC and the execution condition for CHO including CPAC are met simultaneously, the UE may execute CHO without CPAC.

The CHO without CPAC may or may not include SCG configuration. If the CHO without CPAC include SCG configuration, since the SCG is blindly added upon conditional handover, the quality of the SCG is not guaranteed. If the CHO without CPAC doesn't include the SCG configuration, the UE cannot use SCG upon conditional handover. Therefore, if the execution condition for CHO without CPAC and the execution condition for CHO including CPAC are met simultaneously, it is better for UE to execute CHO including CPAC so that the UE can add a qualified SCG upon conditional handover.

Therefore, studies for conditional mobility configuration in a wireless communication system are required.

Hereinafter, a method for conditional mobility configuration in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

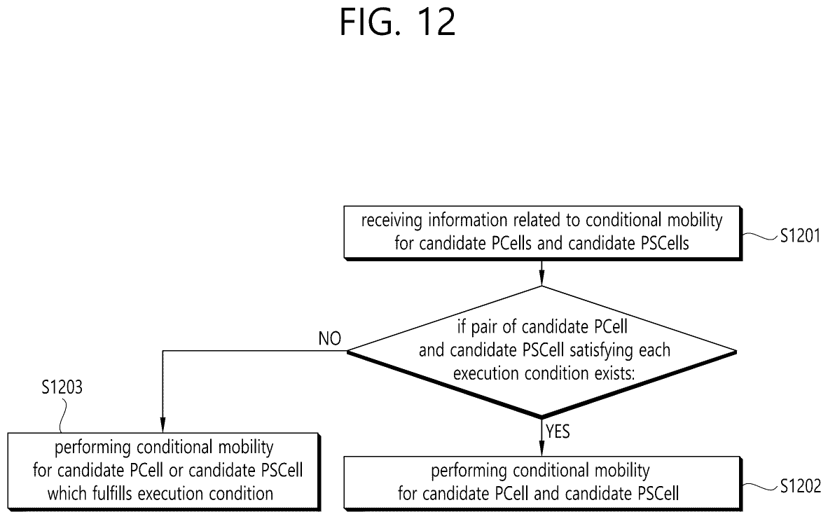

FIG. 12 shows an example of a method for conditional mobility configuration in a wireless communication system, according to some embodiments of the present disclosure.

In particular, FIG. 12 shows an example of a method performed by a wireless device in a wireless communication system.

In step S1201, a wireless device may receive information related to conditional mobility for one or more candidate Primary Cells (PCells) and one or more candidate Primary SCG Cells (PSCells).

For example, the wireless device may receive a radio resource control (RRC) reconfiguration message from the network. The information related to conditional mobility for one or more candidate PCells and one or more candidate PSCells may be included in the RRC reconfiguration message.

For example, the information related to conditional mobility for one or more candidate PCells and one or more candidate PSCells may include (i) information related to one or more execution conditions for the one or more candidate PCells and (ii) information related to one or more execution conditions for the one or more candidate PSCells.

For example, each execution condition may be included in a conditional reconfiguration. In other words, the conditional reconfiguration may include (i) an execution condition, (ii) a conditional reconfiguration ID, and (iii) an RRC reconfiguration.

For example, the wireless device may evaluate a conditional reconfiguration related to the conditional mobility for one or more candidate PCells and one or more candidate PSCells.

For example, the wireless device may perform measurements for the one or more candidate PCells and the one or more candidate PSCells to evaluate the conditional reconfiguration.

For example, the wireless device may receive, from a network, a conditional reconfiguration for a conditional handover for a PCell with a conditional PSCell addition or change for a PSCell. In this case, the conditional reconfiguration may be related to the pair of a candidate PCell and a candidate PSCell related to the candidate PCell.

For example, the wireless device may receive, from a network, a conditional reconfiguration only for a conditional handover for a PCell without a conditional PSCell addition or change for a PSCell. In this case, the conditional reconfiguration may be related to a candidate PCell.

In step S1202, based on that a pair of a candidate PCell and a candidate PSCell related to the candidate PCell satisfying each execution condition for the conditional mobility exists, a wireless device may perform the conditional mobility for the candidate PCell and the candidate PSCell.

For example, the pair of a candidate PCell and a candidate PSCell related to the candidate PCell satisfying each execution condition for the conditional mobility may include (i) a candidate PCell satisfying an execution condition for the candidate PCell and (ii) a PSCell related to the candidate PCell satisfying an execution condition for the candidate PSCell.

For example, the conditional mobility for the candidate PCell and the candidate PSCell may include (i) a conditional handover for the candidate PCell and (ii) a conditional PSCell addition or change for the candidate PSCell.

For example, based on that a pair of a candidate PCell and a candidate PSCell related to the candidate PCell satisfying each execution condition for the conditional mobility exists, the wireless device may prioritize a conditional mobility configuration related to the pair of a candidate PCell and a candidate PSCell related to the candidate PCell satisfying each execution condition for the conditional mobility over at least one conditional mobility configuration related to a single candidate PCell or a single candidate PSCell.

For example, based on that a pair of a candidate PCell and a candidate PSCell related to the candidate PCell satisfying each execution condition for the conditional mobility exists, the wireless device may select a conditional mobility configuration related to the pair of a candidate PCell and a candidate PSCell related to the candidate PCell satisfying each execution condition for the conditional mobility among multiple conditional mobility configurations.

For example, based on that a pair of a candidate PCell and a candidate PSCell related to the candidate PCell satisfying each execution condition for the conditional mobility exists, the wireless device may apply a conditional mobility configuration related to the pair of a candidate PCell and a candidate PSCell related to the candidate PCell satisfying each execution condition for the conditional mobility.

In step S1203, based on that a pair of a candidate PCell and a candidate PSCell related to the candidate PCell satisfying each execution condition for the conditional mobility does not exist, a wireless device may perform the conditional mobility for a candidate PCell or a candidate PSCell which fulfills an execution condition.

According to some embodiments of the present disclosure, the wireless device may be in communication with at least one of a user equipment, a network, or an autonomous vehicle other than the wireless device.

Hereinafter, technical features for handling conditional mobility configuration.

If the first execution condition which is associated with the first CHO configuration and the second execution condition which is associated with the second CHO configuration are met at the same time, UE selects one CHO configuration to execute based on whether the CHO configuration is “CHO with CPAC” or “CHO without CPAC”.

If the first execution condition which is associated with “CHO without CPAC” and the second execution condition which is associated with “CHO with CPAC” are satisfied at the same time, UE prioritizes the “CHO with CPAC” over the “CHO without CPAC”, i.e., deprioritizes the “CHO without CPAC”.

If the execution conditions for more than one CHO configuration are met at the same time, UE selects one CHO configuration to execute among prioritized CHO configurations.

CHO with CPAC Configuration:

“CHO with CPAC” configuration consists of candidate PCell configuration, CHO condition, candidate PSCell configuration, and CPAC (i.e., CPA or CPC) condition.

The execution condition of the CHO with CPAC consists of CHO condition and CPAC condition. UE considers the execution condition is met only when both CHO condition and CPAC condition are met. If both CHO condition and CPAC condition indicated in the CHO with CPAC configuration are met, the UE executes the CHO and CPAC in accordance with the CHO with CPAC configuration. If CHO condition in the CHO with CPAC configuration is met but CPAC condition in the CHO with CPAC configuration is not met, UE takes no action with regard to the CHO with CPAC configuration, i.e., doesn't execute the CHO.

CHO without CPAC Configuration:

“CHO without CPAC” configuration includes CHO execution condition only and does not include CPAC execution condition.

If the CHO condition in the CHO without CPAC configuration is met, the UE executes the CHO in accordance with the CHO without CPAC configuration.

Case 1: Prioritization of CHO Configurations Associated with the Same Candidate PCell

If execution conditions of the CHO configurations for the same candidate PCell are met at the same time, UE prioritizes CHO with CPAC configurations over CHO without CPAC configuration.

For instance, for a candidate PCell, i.e., cell #1, 3-CHO configurations are configured as follow:
CHO configuration #1: CHO without CPAC configuration, candidate PCell=cell #1.
CHO configuration #2: CHO with CPAC configuration, candidate PCell=cell #1 and candidate PSCell=cell #2.
CHO configuration #3: CHO with CPAC configuration, candidate PCell=cell #1 and candidate PSCell=cell #3.

If execution conditions of CHO configuration #1, #2 and #3 are met at the same time, the UE prioritizes the CHO configuration #2 and #3 over #1. That is, UE selects one between CHO configuration #2 and #3 to execute.

The candidate PSCell priority can be considered to select one CHO configuration. If the priority of each candidate PSCell is configured by network, UE selects a CHO with CPAC configuration associated with the highest priority.

Case 2: Prioritization of CHO Configurations Associated with Different Candidate PCells.

Different candidate PCell may have different priority. If the first execution condition of CHO for the first candidate PCell and the second execution condition of CHO for the second candidate PCell are met at the same time, the UE selects one CHO configuration associated with the highest candidate PCell priority among CHO configurations for which the corresponding execution condition is met, and executes CHO according to the selected CHO configuration.

If the first execution condition of CHO for the first candidate PCell and the second execution condition of CHO for the second candidate PCell are met at the same time, and if the first candidate PCell and the second candidate PCell have the same priority, UE selects one CHO configuration to execute based on whether the CHO configuration is CHO with CPAC or CHO without CPAC.

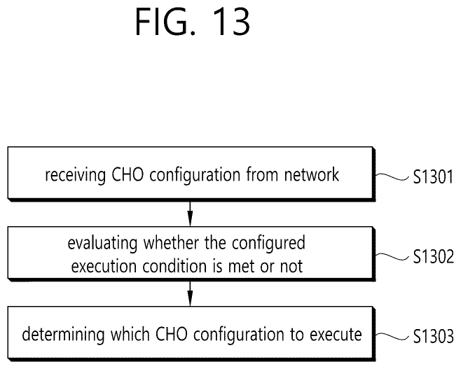

FIG. 13 shows an example for prioritization of conditional mobility configuration according to some embodiments of the present disclosure.

In particular, FIG. 13 shows an example of a method performed by a UE in a wireless communication system.

In step S1301, UE may receive CHO configuration from network.

UE receives a first conditional mobility configuration which is as follows:

The first conditional mobility configuration includes a configuration on a first candidate PCell and a first execution condition associated with the first candidate PCell.

The first conditional mobility configuration does not include execution condition for PSCell.

The first conditional mobility configuration may or may include a configuration on candidate PSCell.

If the first execution condition associated with the first candidate PCell is met, i.e. if the measurement results of the first candidate PCell satisfies the first execution condition, the UE executes the conditional mobility according to the first conditional mobility configuration, i.e. applies the configuration on the first candidate PCell and the candidate PSCell, if configured.

The execution condition associated with the first candidate PCell may be condEvent A3, condEvent A4 or condEvent A5.

UE receives a second conditional mobility configuration which is as follows:

The second conditional mobility configuration includes a configuration on the first candidate PCell and a candidate PSCell, and a second execution condition associated with the first candidate PCell and the candidate PSCell.

The second execution condition consists of an execution condition associated with the first candidate PCell and an execution condition associated with the candidate PSCell. UE considers the second execution condition is met, if both the execution condition associated with the first candidate PCell and the execution condition associated with the candidate PSCell are met.

If the second execution condition associated with the first candidate PCell and the candidate PSCell is met, the UE executes the conditional mobility according to the second conditional mobility configuration, i.e. applies the configuration on the first candidate PCell and the candidate PSCell.

The execution condition associated with the first candidate PCell may be condEvent A3, condEvent A4 or condEvent A5. The execution condition associated with the candidate PSCell may be condEvent A3, condEvent A4 or condEvent A5.

In step S1302, UE may evaluate whether the configured execution condition is met or not.

UE performs measurements on the first candidate PCell and candidate PSCell. UE evaluates whether the first execution condition and the second execution condition are met based on the measurement results of the first candidate PCell and the candidate PSCell.

In step S1303, UE may determine which CHO configuration to execute.

If the first execution condition is met first, the UE executes the conditional mobility according to the first conditional mobility configuration. If the second execution condition is met first, the UE executes the conditional mobility according to the second conditional mobility configuration.

If the first execution condition and the second execution condition are met at the same time, the UE executes the conditional mobility according to the second conditional mobility configuration. UE applies the configuration on the first candidate PCell and the candidate PSCell included in the second conditional mobility configuration.

If the first execution condition and the second execution condition are met at the same time, the UE prioritizes the second conditional mobility configuration over the first conditional mobility configuration.

If more than one conditional mobility configurations are prioritized, the UE selects one among them and executes conditional mobility according to the selected conditional mobility configuration.

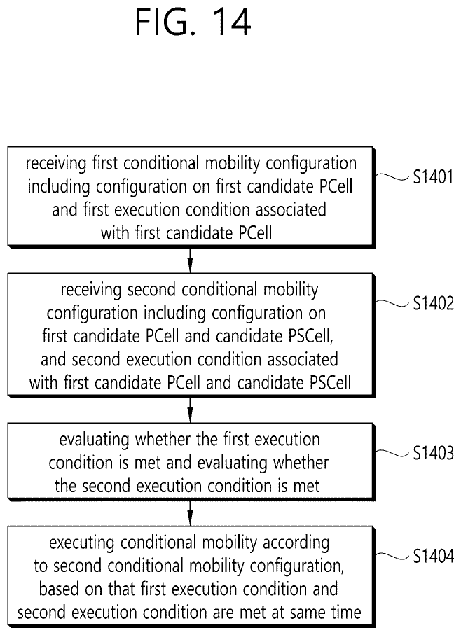

FIG. 14 shows an example for prioritizing conditional mobility configuration according to some embodiments of the present disclosure.

In particular, FIG. 14 shows an example of a method performed by a wireless device in a wireless communication system.

In step S1401, the wireless device may receive a first conditional mobility configuration including a configuration on a first candidate PCell and a first execution condition associated with the first candidate PCell.

In step S1402, the wireless device may receive a second conditional mobility configuration including a configuration on the first candidate PCell and a candidate PSCell, and a second execution condition associated with the first candidate PCell and the candidate PSCell.

For example, the second execution condition consists of a condition associated with the first candidate PCell and a condition associated with the candidate PSCell.

In step S1403, the wireless device may evaluate whether the first execution condition is met and evaluate whether the second execution condition is met.

In step S1404, if the first execution condition and the second execution condition are met at the same time, the wireless device may execute the conditional mobility according to the second conditional mobility configuration.

That is, the wireless device may apply the configuration on the first candidate PCell and the candidate PSCell in the second conditional mobility configuration.

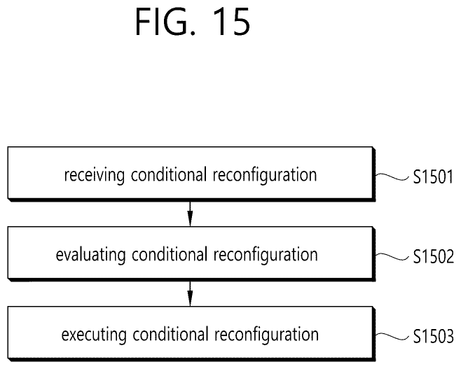

FIG. 15 shows an example for handling conditional mobility configuration according to some embodiments of the present disclosure.

In particular, FIG. 15 shows an example of a method performed by a UE in a wireless communication system.

In step S1501, the UE may receive a conditional reconfiguration from a network.

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition.

The network can also configure the UE with one or more candidate target PCells associated with one or more candidate target PSCells. The UE evaluates the conditions for the candidate target PCells and the associated candidate target PSCells in parallel and applies a target configuration that include PCell and PSCell for which the associated execution conditions are fulfiled. If there are multiple candidate PSCells associated with one candidate target PCell, the network provides multiple conditional configurations for the same candidate target PCell, i.e., each configuration contains one MCG configuration (for the same candidate target PCell) and one SCG configuration (for one of the multiple associated candidate PSCells). For this case, the network may also provide a complementary CHO only configuration, i.e., there is execution condition only for candidate PCell.

The network provides the configuration parameters for the target SpCell(s) in the condRRCReconfig.

In NR-DC, the UE may receive two independent conditionalReconfiguration:
a conditionalReconfiguration associated with MCG, that is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

In this case:
the UE maintains two independent VarConditionalReconfig, one associated with each conditionalReconfiguration;
the UE independently performs all the procedures for each conditionalReconfiguration and the associated VarConditionalReconfig, unless explicitly stated otherwise;
the UE performs the procedures in clause 5.5 for the VarConditionalReconfig associated with the same cell group like the measConfig.

In EN-DC, the VarConditionalReconfig is associated with the SCG.

In NE-DC and when no SCG is configured, the VarConditionalReconfig is associated with the MCG.

In step S1502, the UE may evaluate the conditional reconfiguration.

The UE shall:
1> for each condReconfigId within the VarConditionalReconfig:
2>f the RRCReconfiguration within condRRCReconfig includes the masterCellGroup including the reconfigurationWithSync:
3> if the associated condExecutionCondPSCell is configured:
4> consider the cell which has a physical cell identity matching the value indicated in the ServingCellConfigCommon included in the reconfigurationWithSync within the masterCellGroup in the received condRRCReconfig to be applicable cell; and
4> consider the cell which has a physical cell identity matching the value indicated in the ServingCellConfigCommon included in the reconfigurationWithSync within the secondaryCellGroup within the nr-SCG within the received condRRCReconfig to be applicable cell;
3> else:
4> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfigurationWithSync:
3> if the cell which has a physical cell identity matching the value indicated in the ServingCellConfigCommon included in the reconfigurationWithSync within the secondaryCellGroup within the received condRRCReconfig is not the PSCell; and
4> if the condReconfigToAddMod for the condReconfigId does not include subsequentCondReconfig; or
4> if there is no condReconfigToAddMod which includes subsequentCondReconfig for the PSCell; or
4> if the condReconfigToAddMod for the condReconfigId includes subsequentCondReconfig and there is a condReconfigToAddMod which includes subsequentCondReconfig with a matching condReconfigId value in condExecutionCondToAddModList for the PSCell:
5> consider the cell to be applicable cell;
2> if condExecutionCondSCG is configured and condExecutionCond is not configured:
3> in the remainder of the procedure, consider each measId indicated in the condExecutionCondSCG as a measId in the VarMeasConfig associated with the SCG measConfig;
2> if the condExecutionCondPSCell is configured:
3> in the remainder of the procedure, consider each measId indicated in the condExecutionCondPSCell as a measId in the VarMeasConfig associated with the MCG measConfig;
2> if condExecutionCond is configured and condExecutionCondSCG is not configured:
3> if it is configured via SRB3 or configured within nr-SCG or within nr-SecondaryCellGroupConfig via SRB1:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> if subsequentCondReconfig is included in the entry in MCG VarConditionalReconfig associated with this condReconfigId:
3> if the UE is in NR-DC:
4> in the remainder of the procedure, consider each measId indicated in the condExecutionCondSCG as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond, condExecutionCondSCG, or condExecutionCondPSCell associated to condReconfigId:
3> if the condTriggerConfig is not configured with nesEvent:
4> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
4> if the condEventId is associated with condEventD1 or condEventD2, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding time ToTrigger defined for this event within the VarConditionalReconfig; or
4> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time ToTrigger defined for this event within the VarConditionalReconfig:
5> consider the event associated to that measId to be fulfilled;
4> if the measId for this event associated with the condReconfigId has been modified; or
4> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
4> if the condEventId is associated with condEventD1 or condEventD2, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding time ToTrigger defined for this event within the VarConditionalReconfig; or
4> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time ToTrigger defined for this event within the VarConditionalReconfig:
5> consider the event associated to that measId to be not fulfilled;
3> else:
4> if NES mode indication is received from lower layers, indicating that the NES-specific CHO execution condition of the PCell is enabled; and
4> if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time ToTrigger defined for this event within the VarConditionalReconfig:
5> consider the event associated to that measId to be fulfilled;
4> if the measId for this event associated with the condReconfigId has been modified; or
4> if NES mode indication is received from lower layers, indicating that the NES-specific CHO execution condition of the PCell is disabled; or
4> if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time ToTrigger defined for this event within the VarConditionalReconfig:
5> consider the event associated to that measId to be not fulfilled;
2> if condExecutionCondPSCell is not configured:
3> if event(s) associated to all measId(s) within condTriggerConfig for the applicable cell are fulfilled:
4> consider the applicable cell, associated to that condReconfigId, as a triggered cell;
4> initiate the conditional reconfiguration execution;
2> else:
3> if event(s) associated to all measId(s), as indicated in the condExecutionCond and condExecutionCondPSCell, within condTriggerConfig for a target candidate cell within the stored condRRCReconfig are fulfilled:
4> consider the target candidate PCell within the stored condRRCReconfig, associated to that condReconfigId, as a triggered PCell;
4> consider the target candidate PSCell within the stored condRRCReconfig, associated to that condReconfigId, as a triggered PSCell;
4> initiate the conditional reconfiguration execution.
2> if one of the events associated to the measIds within condTriggerConfig for the applicable cell within the stored condRRCReconfig is not configured with nesEvent, and the other event associated to the measIds within condTriggerConfig for the applicable cell within the stored condRRCReconfig is configured with nesEvent, and at least one of them is fulfilled:
3> consider the applicable cell within the stored condRRCReconfig, associated to that condReconfigId, as a triggered cell;
3> initiate the conditional reconfiguration execution;

For example, up to 2 MeasId can be configured for each condReconfigId, if condExecutionCondPSCell is not configured. The conditional reconfiguration event of the 2 MeasId may have the same or different event conditions, triggering quantity, time to trigger, and triggering threshold.

For example, for CHO with candidate SCG(s), up to 2 MeasId can be configured for condExecutionCond and up to 2 MeasId can be configured for condExecutionCondPSCell for each condReconfigId.

In step S1503, the UE may execute the conditional reconfiguration.

The UE shall:
1> if more than one pair of triggered PCell and associated triggered PSCell exist:
2> select one of the triggered PCell(s) and the associated triggered PSCell(s) as the selected cells for conditional reconfiguration execution;
1> else if only one pair of triggered PCell and associated triggered PSCell exists:
2> consider the triggered PCell and the associated triggered PSCell as the selected cells for conditional reconfiguration execution;
1> else if more than one triggered cell exists:
2> select one of the triggered cells as the selected cell for conditional reconfiguration execution;
1> else:
2> consider the triggered cell as the selected cell for conditional reconfiguration execution;
1> for the selected cell(s) of conditional reconfiguration execution:
2> if the subsequentCondReconfig is included in the entry in VarConditionalReconfig containing the RRCReconfiguration message for the selected cell:
3> perform the actions according to subsequent CPAC execution;
2> else:
3> apply the stored condRRCReconfig of the selected cell and perform the actions related to reception of an RRCReconfiguration by the UE;

For example, if multiple NR cells are triggered in conditional reconfiguration execution, it is up to UE implementation which one to select, e.g. the UE considers beams and beam quality to select one of the triggered cells for execution.

Hereinafter, technical features related to conditional reconfiguration are as below.

For example, the conditional reconfiguration may be included in a radio resource control (RRC) reconfiguration message.

For example, the IE ConditionalReconfiguration is used to add, modify and release the configuration of conditional reconfiguration.

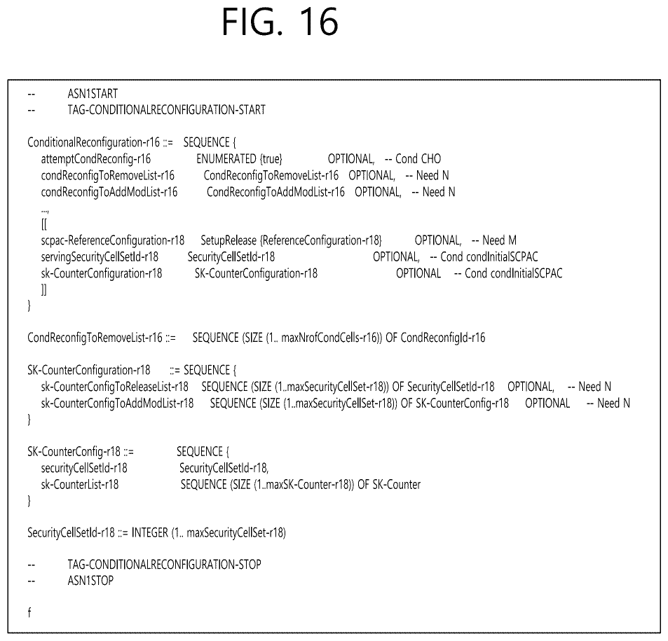

FIG. 16 shows an example of ConditionalReconfiguration information element.

The ConditionalReconfiguration may include a condReconfigToAddModList.
attemptCondReconfig: If present, the UE shall perform conditional reconfiguration if selected cell is a target candidate cell and it is the first cell selection after failure.
condReconfigToAddModList: List of the configuration of candidate SpCells to be added or modified for CHO, CPA or CPC.
condReconfigToRemoveList: List of the configuration of candidate SpCells to be removed.
scpac-ReferenceConfiguration: Includes the reference configuration for the candidate supporting subsequent CPAC.
securityCellSetId: This field is used to determine whether UE should perform security update when conditional reconfiguration containing subsequentCondReconfig is executed.
servingSecurityCellSetId: This field identifies the security cell set for serving PSCell.
sk-counterConfiguration: Includes a list of sk-Counter from which the UE should select the sk-counter used to derive S-KgNB for inter-SN subsequent CPAC. If this field is configured, the network shall not configure the field sk-Counter within the RRCReconfiguration message for conditional reconfiguration execution for subsequent CPAC.
CHO: The field is optional present, Need R, if the UE is configured with at least a candidate SpCell for CHO. Otherwise the field is not present.
condInitialSCPAC: The field is mandatory present upon the initial conditional reconfiguration, generated by the MN, which includes at least one inter-SN candidate PSCell supporting subsequent CPAC. The field is absent for any conditional reconfiguration generated by the SN. Otherwise, the field is optional, need M.

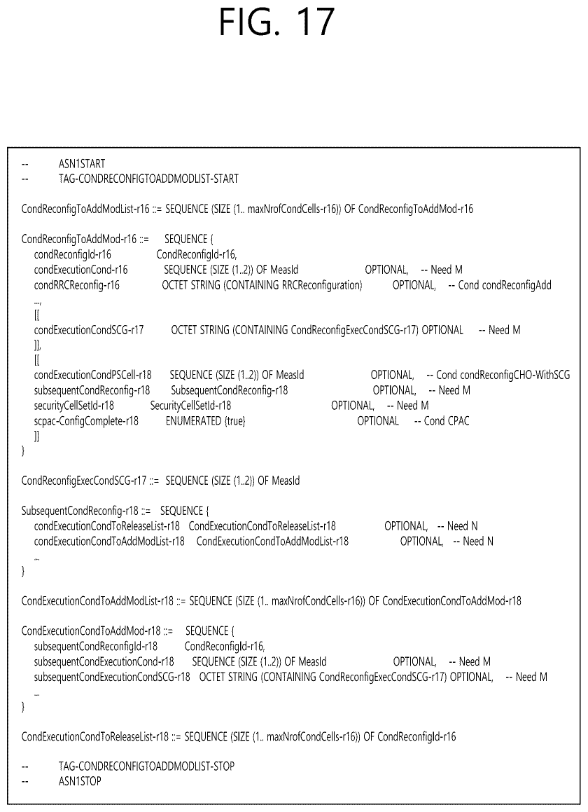

FIG. 17 shows an example of CondReconfigToAddModList information element.

For example, the IE CondReconfigToAddModList concerns a list of conditional reconfigurations to add or modify, with for each entry the condReconfigId and the associated fields.

The CondReconfigToAddModList may include information related to condReconfigId, condExecutionCond, condRRCReconfig, condRRCReconfig, condExecutionCondPSCell, and/or subsequentCondReconfig.
condExecutionCond: The execution condition that needs to be fulfilled in order to trigger the execution of a conditional reconfiguration for CHO, CPA, intra-SN CPC without MN involvement, or MN initiated inter-SN CPC. When configuring 2 triggering events (Meas Ids) for a candidate cell, the network ensures that both refer to the same measObject. The network configures at most one from condEventD1, condEventD2 or condEventT1 for the same candidate cell. For CPA and for MN-initiated inter-SN CPC, the network only indicates MeasId(s) associated with condEventA4. For intra-SN CPC, the network only indicates MeasId(s) associated with condEventA3 or condEventA5.
condExecutionCondPSCell: The execution condition that needs to be fulfilled for the associated PSCell in order to trigger the execution of a conditional reconfiguration for CHO with candidate SCG(s). The Meas Ids refer to the measConfig associated with the MCG. When configuring 2 triggering events (Meas Ids) for a candidate cell, network ensures that both refer to the same measObject. The network only indicates MeasId(s) associated with condEventA4.
condExecutionCondSCG: Contains execution condition that needs to be fulfilled in order to trigger the execution of a conditional reconfiguration for SN initiated inter-SN CPC. The Meas Ids refer to the measConfig associated with the SCG. When configuring 2 triggering events (Meas Ids) for a candidate cell, network ensures that both refer to the same measObject. For each condReconfigId, the network always configures either condExecutionCond or condExecutionCondSCG (not both). The network only indicates MeasId(s) associated with condEventA3 or condEventA5.
condRRCReconfig: The RRCReconfiguration message to be applied when the condition(s) are fulfilled. The RRCReconfiguration message contained in condRRCReconfig cannot contain the field conditionalReconfiguration or the field daps-Config.
scpac-ConfigComplete: This field indicates whether the configuration contained in condRRCReconfig for subsequent CPAC is a complete configuration.
subsequentCondReconfig: Contains the execution conditions that need to be fulfilled in order to trigger the execution of a subsequent CPAC. If the field is configured, the configuration of candidate PSCells for subsequent CPAC is supported. The subsequent execution condition is used for conditional reconfiguration evaluation for other candidate cells when the RRCReconfiguration message contained in condRRCReconfig has been applied.
subsequentCondExecutionCond: The execution condition that needs to be fulfilled in order to trigger the execution of a conditional reconfiguration for SN initiated intra-SN subsequent CPAC without MN involvement. When configuring 2 triggering events (Meas Ids) for a candidate cell, the network ensures that both refer to the same measObject. The network only indicates MeasId(s) associated with condEventA3 or condEventA5.
subsequentCondExecutionCondSCG: Contains execution condition that needs to be fulfilled in order to trigger the execution of a conditional reconfiguration for SN initiated inter-SN subsequent CPAC, SN initiated intra-SN subsequent CPAC with MN involvement, or MN initiated inter-SN subsequent CPAC. The Meas Ids refer to the measConfig associated with the SCG. When configuring 2 triggering events (Meas Ids) for a candidate cell, network ensures that both refer to the same measObject. The network only indicates MeasId(s) associated with condEventA3 or condEventA5.
condReconfigAdd: The field is mandatory present when a condReconfigId is being added. Otherwise the field is optional, need M.
condReconfigCHO-WithSCG: This field is optional present, need M, if the RRCReconfiguration message contained in corresponding condRRCReconfig includes the nr-SCG and condExecutionCond is configured. Otherwise, it is absent.
CPAC: The field is optionally present, need M, when the conditional reconfiguration includes at least one candidate PSCell supporting subsequent CPAC. Otherwise, the field is absent, need R.

Some of the detailed steps shown in the examples of FIGS. 12, 13, 14, 15, 16, and 17 may not be essential steps and may be omitted. In addition to the steps shown in FIGS. 12, 13, 14, 15, 16, and 17, other steps may be added, and the order of the steps may vary. Some of the above steps may have their own technical meaning.

Hereinafter, an apparatus for conditional mobility configuration in a wireless communication system, according to some embodiments of the present disclosure, will be described. Herein, the apparatus may be a wireless device (100 or 200) in FIGS. 2, 3, and 5.

For example, a wireless device may perform methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

For example, the wireless device may include at least one transceiver, at least one processor, and at least one memory operably connectable to the at least one processor and storing instructions that, based on being executed by the at least one processor, perform operations.

The processor 102 may be adapted to control the transceiver 106 to receive information related to conditional mobility for one or more candidate Primary Cells (PCells) and one or more candidate Primary Secondary Cell Group (SCG) Cells (PSCells). Based on that a pair of a candidate PCell and a candidate PSCell related to the candidate PCell satisfying each execution condition for the conditional mobility exists, the processor 102 may be adapted to perform the conditional mobility for the candidate PCell and the candidate PSCell. Based on that a pair of a candidate PCell and a candidate PSCell related to the candidate PCell satisfying each execution condition for the conditional mobility does not exist, the processor 102 may be adapted to perform the conditional mobility for a candidate PCell or a candidate PSCell which fulfills an execution condition.

For example, the pair of a candidate PCell and a candidate PSCell related to the candidate PCell satisfying each execution condition for the conditional mobility may include (i) a candidate PCell satisfying an execution condition for the candidate PCell and (ii) a PSCell related to the candidate PCell satisfying an execution condition for the candidate PSCell.

For example, the information related to conditional mobility for one or more candidate PCells and one or more candidate PSCells may be included in a radio resource control (RRC) reconfiguration message.

For example, the information related to conditional mobility for one or more candidate PCells and one or more candidate PSCells may include (i) information related to one or more execution conditions for the one or more candidate PCells and (ii) information related to one or more execution conditions for the one or more candidate PSCells.

For example, the processor 102 may be adapted to evaluate a conditional reconfiguration related to the conditional mobility for one or more candidate PCells and one or more candidate PSCells.

For example, the processor 102 may be adapted to perform measurements for the one or more candidate PCells and the one or more candidate PSCells.

For example, the conditional mobility for the candidate PCell and the candidate PSCell may include (i) a conditional handover for the candidate PCell and (ii) a conditional PSCell addition or change for the candidate PSCell.

For example, based on that a pair of a candidate PCell and a candidate PSCell related to the candidate PCell satisfying each execution condition for the conditional mobility exists, the processor 102 may be adapted to prioritize a conditional mobility configuration related to the pair of a candidate PCell and a candidate PSCell related to the candidate PCell satisfying each execution condition for the conditional mobility over at least one conditional mobility configuration related to a single candidate PCell or a single candidate PSCell.

For example, based on that a pair of a candidate PCell and a candidate PSCell related to the candidate PCell satisfying each execution condition for the conditional mobility exists, the processor 102 may be adapted to select a conditional mobility configuration related to the pair of a candidate PCell and a candidate PSCell related to the candidate PCell satisfying each execution condition for the conditional mobility among multiple conditional mobility configurations.

For example, based on that a pair of a candidate PCell and a candidate PSCell related to the candidate PCell satisfying each execution condition for the conditional mobility exists, the processor 102 may be adapted to apply a conditional mobility configuration related to the pair of a candidate PCell and a candidate PSCell related to the candidate PCell satisfying each execution condition for the conditional mobility.

For example, the processor 102 may be adapted to control the transceiver 106 to receive, from a network, a conditional reconfiguration for a conditional handover for a PCell with a conditional PSCell addition or change for a PSCell.

For example, the processor 102 may be adapted to control the transceiver 106 to receive, from a network, a conditional reconfiguration only for a conditional handover for a PCell without a conditional PSCell addition or change for a PSCell.

For example, the processor 102 may be adapted to be in communication with at least one of a user equipment, a network, or an autonomous vehicle other than the wireless device.

Hereinafter, a processor for a wireless device for conditional mobility configuration in a wireless communication system, according to some embodiments of the present disclosure, will be described.

The processor may be adapted to control the wireless device to receive information related to conditional mobility for one or more candidate Primary Cells (PCells) and one or more candidate Primary Secondary Cell Group (SCG) Cells (PSCells). Based on that a pair of a candidate PCell and a candidate PSCell related to the candidate PCell satisfying each execution condition for the conditional mobility exists, the processor may be adapted to control the wireless device to perform the conditional mobility for the candidate PCell and the candidate PSCell. Based on that a pair of a candidate PCell and a candidate PSCell related to the candidate PCell satisfying each execution condition for the conditional mobility does not exist, the processor may be adapted to control the wireless device to perform the conditional mobility for a candidate PCell or a candidate PSCell which fulfills an execution condition.

For example, the pair of a candidate PCell and a candidate PSCell related to the candidate PCell satisfying each execution condition for the conditional mobility may include (i) a candidate PCell satisfying an execution condition for the candidate PCell and (ii) a PSCell related to the candidate PCell satisfying an execution condition for the candidate PSCell.

For example, the information related to conditional mobility for one or more candidate PCells and one or more candidate PSCells may be included in a radio resource control (RRC) reconfiguration message.

For example, the information related to conditional mobility for one or more candidate PCells and one or more candidate PSCells may include (i) information related to one or more execution conditions for the one or more candidate PCells and (ii) information related to one or more execution conditions for the one or more candidate PSCells.

For example, the processor may be adapted to control the wireless device to evaluate a conditional reconfiguration related to the conditional mobility for one or more candidate PCells and one or more candidate PSCells.

For example, the processor may be adapted to control the wireless device to perform measurements for the one or more candidate PCells and the one or more candidate PSCells.

For example, the conditional mobility for the candidate PCell and the candidate PSCell may include (i) a conditional handover for the candidate PCell and (ii) a conditional PSCell addition or change for the candidate PSCell.

For example, based on that a pair of a candidate PCell and a candidate PSCell related to the candidate PCell satisfying each execution condition for the conditional mobility exists, the processor may be adapted to control the wireless device to prioritize a conditional mobility configuration related to the pair of a candidate PCell and a candidate PSCell related to the candidate PCell satisfying each execution condition for the conditional mobility over at least one conditional mobility configuration related to a single candidate PCell or a single candidate PSCell.

For example, based on that a pair of a candidate PCell and a candidate PSCell related to the candidate PCell satisfying each execution condition for the conditional mobility exists, the processor may be adapted to control the wireless device to select a conditional mobility configuration related to the pair of a candidate PCell and a candidate PSCell related to the candidate PCell satisfying each execution condition for the conditional mobility among multiple conditional mobility configurations.

For example, based on that a pair of a candidate PCell and a candidate PSCell related to the candidate PCell satisfying each execution condition for the conditional mobility exists, the processor may be adapted to control the wireless device to apply a conditional mobility configuration related to the pair of a candidate PCell and a candidate PSCell related to the candidate PCell satisfying each execution condition for the conditional mobility.

For example, the processor may be adapted to control the wireless device to receive, from a network, a conditional reconfiguration for a conditional handover for a PCell with a conditional PSCell addition or change for a PSCell.

For example, the processor may be adapted to control the wireless device to receive, from a network, a conditional reconfiguration only for a conditional handover for a PCell without a conditional PSCell addition or change for a PSCell.

For example, the processor may be adapted to control the wireless device to be in communication with at least one of a user equipment, a network, or an autonomous vehicle other than the wireless device.

Hereinafter, a non-transitory computer-readable medium has stored thereon a plurality of instructions for conditional mobility configuration in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive information related to conditional mobility for one or more candidate Primary Cells (PCells) and one or more candidate Primary Secondary Cell Group (SCG) Cells (PSCells). Based on that a pair of a candidate PCell and a candidate PSCell related to the candidate PCell satisfying each execution condition for the conditional mobility exists, the stored a plurality of instructions may cause the wireless device to perform the conditional mobility for the candidate PCell and the candidate PSCell. Based on that a pair of a candidate PCell and a candidate PSCell related to the candidate PCell satisfying each execution condition for the conditional mobility does not exist, the stored a plurality of instructions may cause the wireless device to perform the conditional mobility for a candidate PCell or a candidate PSCell which fulfills an execution condition.

For example, the pair of a candidate PCell and a candidate PSCell related to the candidate PCell satisfying each execution condition for the conditional mobility may include (i) a candidate PCell satisfying an execution condition for the candidate PCell and (ii) a PSCell related to the candidate PCell satisfying an execution condition for the candidate PSCell.

For example, the information related to conditional mobility for one or more candidate PCells and one or more candidate PSCells may be included in a radio resource control (RRC) reconfiguration message.

For example, the information related to conditional mobility for one or more candidate PCells and one or more candidate PSCells may include (i) information related to one or more execution conditions for the one or more candidate PCells and (ii) information related to one or more execution conditions for the one or more candidate PSCells.

For example, the stored a plurality of instructions may cause the wireless device to evaluate a conditional reconfiguration related to the conditional mobility for one or more candidate PCells and one or more candidate PSCells.

For example, the stored a plurality of instructions may cause the wireless device to perform measurements for the one or more candidate PCells and the one or more candidate PSCells.

For example, the conditional mobility for the candidate PCell and the candidate PSCell may include (i) a conditional handover for the candidate PCell and (ii) a conditional PSCell addition or change for the candidate PSCell.

For example, based on that a pair of a candidate PCell and a candidate PSCell related to the candidate PCell satisfying each execution condition for the conditional mobility exists, the stored a plurality of instructions may cause the wireless device to prioritize a conditional mobility configuration related to the pair of a candidate PCell and a candidate PSCell related to the candidate PCell satisfying each execution condition for the conditional mobility over at least one conditional mobility configuration related to a single candidate PCell or a single candidate PSCell.

For example, based on that a pair of a candidate PCell and a candidate PSCell related to the candidate PCell satisfying each execution condition for the conditional mobility exists, the stored a plurality of instructions may cause the wireless device to select a conditional mobility configuration related to the pair of a candidate PCell and a candidate PSCell related to the candidate PCell satisfying each execution condition for the conditional mobility among multiple conditional mobility configurations.

For example, based on that a pair of a candidate PCell and a candidate PSCell related to the candidate PCell satisfying each execution condition for the conditional mobility exists, the stored a plurality of instructions may cause the wireless device to apply a conditional mobility configuration related to the pair of a candidate PCell and a candidate PSCell related to the candidate PCell satisfying each execution condition for the conditional mobility.

For example, the stored a plurality of instructions may cause the wireless device to receive, from a network, a conditional reconfiguration for a conditional handover for a PCell with a conditional PSCell addition or change for a PSCell.

For example, the stored a plurality of instructions may cause the wireless device to receive, from a network, a conditional reconfiguration only for a conditional handover for a PCell without a conditional PSCell addition or change for a PSCell.

For example, the stored a plurality of instructions may cause the wireless device to be in communication with at least one of a user equipment, a network, or an autonomous vehicle other than the wireless device.

Hereinafter, a method performed by a base station (BS) for conditional mobility configuration in a wireless communication system, according to some embodiments of the present disclosure, will be described.

The BS may transmit, to a wireless device, information related to conditional mobility for one or more candidate Primary Cells (PCells) and one or more candidate Primary SCG Cells (PSCells). For example, based on that a pair of a candidate PCell and a candidate PSCell related to the candidate PCell satisfying each execution condition for the conditional mobility exists, the wireless device performs the conditional mobility for the candidate PCell and the candidate PSCell. For other example, based on that a pair of a candidate PCell and a candidate PSCell related to the candidate PCell satisfying each execution condition for the conditional mobility does not exist, the wireless device performs the conditional mobility for a candidate PCell or a candidate PSCell which fulfills an execution condition.

Hereinafter, a base station (BS) for conditional mobility configuration in a wireless communication system, according to some embodiments of the present disclosure, will be described.

The BS may include a transceiver, a memory, and a processor operatively coupled to the transceiver and the memory.

The processor may be adapted to control the transceiver to transmit, to a wireless device, information related to conditional mobility for one or more candidate Primary Cells (PCells) and one or more candidate Primary SCG Cells (PSCells). For example, based on that a pair of a candidate PCell and a candidate PSCell related to the candidate PCell satisfying each execution condition for the conditional mobility exists, the wireless device performs the conditional mobility for the candidate PCell and the candidate PSCell. For other example, based on that a pair of a candidate PCell and a candidate PSCell related to the candidate PCell satisfying each execution condition for the conditional mobility does not exist, the wireless device performs the conditional mobility for a candidate PCell or a candidate PSCell which fulfills an execution condition.

The present disclosure can have various advantageous effects.

According to some embodiments of the present disclosure, the wireless device could efficiently handle the conditional mobility configuration by prioritizing the CHO with CPAC over the CHO without CPAC.

For example, the wireless device can use qualified SCG upon conditional handover by applying an SCG which satisfies the execution condition.

In other words, if the execution condition is satisfied, the conditional mobility can be performed using the SCG configuration.

According to some embodiments of the present disclosure, the wireless communication system could provide an efficient solution for handling the conditional mobility configuration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method, comprising:
receiving, by a wireless device, information related to conditional mobility for one or more candidate Primary Cells (PCells) and one or more candidate Primary Secondary Cell Group (SCG) Cells (PSCells);
based on that a pair of a candidate PCell and a candidate PSCell related to the candidate PCell satisfying each execution condition for the conditional mobility exists:
performing, by the wireless device, the conditional mobility for the candidate PCell and the candidate PSCell; and
based on that a pair of a candidate PCell and a candidate PSCell related to the candidate PCell satisfying each execution condition for the conditional mobility does not exist:
performing, by the wireless device, the conditional mobility for a candidate PCell or a candidate PSCell which fulfills an execution condition.

2. The method of claim 1,
wherein the pair of a candidate PCell and a candidate PSCell related to the candidate PCell satisfying each execution condition for the conditional mobility includes (i) a candidate PCell satisfying an execution condition for the candidate PCell and (ii) a PSCell related to the candidate PCell satisfying an execution condition for the candidate PSCell.

3. The method of claim 1,
wherein the information related to conditional mobility for one or more candidate PCells and one or more candidate PSCells is included in a radio resource control (RRC) reconfiguration message.

4. The method of claim 1,
wherein the information related to conditional mobility for one or more candidate PCells and one or more candidate PSCells includes (i) information related to one or more execution conditions for the one or more candidate PCells and (ii) information related to one or more execution conditions for the one or more candidate PSCells.

5. The method of claim 1, wherein the method further comprises,
evaluating, by the wireless device, a conditional reconfiguration related to the conditional mobility for one or more candidate PCells and one or more candidate PSCells.

6. The method of claim 1, wherein the method further comprises,
performing, by the wireless device, measurements for the one or more candidate PCells and the one or more candidate PSCells.

7. The method of claim 1,
wherein the conditional mobility for the candidate PCell and the candidate PSCell includes (i) a conditional handover for the candidate PCell and (ii) a conditional PSCell addition or change for the candidate PSCell.

8. The method of claim 1, wherein the method further comprises,
based on that a pair of a candidate PCell and a candidate PSCell related to the candidate PCell satisfying each execution condition for the conditional mobility exists:
prioritizing, by the wireless device, a conditional mobility configuration related to the pair of a candidate PCell and a candidate PSCell related to the candidate PCell satisfying each execution condition for the conditional mobility over at least one conditional mobility configuration related to a single candidate PCell or a single candidate PSCell.

9. The method of claim 1, wherein the method further comprises,
based on that a pair of a candidate PCell and a candidate PSCell related to the candidate PCell satisfying each execution condition for the conditional mobility exists:
selecting, by the wireless device, a conditional mobility configuration related to the pair of a candidate PCell and a candidate PSCell related to the candidate PCell satisfying each execution condition for the conditional mobility among multiple conditional mobility configurations.

10. The method of claim 1, wherein the method further comprises,
based on that a pair of a candidate PCell and a candidate PSCell related to the candidate PCell satisfying each execution condition for the conditional mobility exists:
applying, by the wireless device, a conditional mobility configuration related to the pair of a candidate PCell and a candidate PSCell related to the candidate PCell satisfying each execution condition for the conditional mobility.

11. The method of claim 1, wherein the method further comprises,
receiving, by the wireless device, from a network, a conditional reconfiguration for a conditional handover for a PCell with a conditional PSCell addition or change for a PSCell.

12. The method of claim 1, wherein the method further comprises,
receiving, by the wireless device, from a network, a conditional reconfiguration only for a conditional handover for a PCell without a conditional PSCell addition or change for a PSCell.

13. The method of claim 1,
wherein the wireless device is in communication with at least one of a user equipment, a network, or an autonomous vehicle other than the wireless device.

14. A wireless device, comprising:
at least one transceiver;
at least one processor; and
at least one memory operably connectable to the at least one processor and storing instructions that, based on being executed by the at least one processor, perform operations comprising:
receiving information related to conditional mobility for one or more candidate Primary Cells (PCells) and one or more candidate Primary Secondary Cell Group (SCG) Cells (PSCells);
based on that a pair of a candidate PCell and a candidate PSCell related to the candidate PCell satisfying each execution condition for the conditional mobility exists:
performing the conditional mobility for the candidate PCell and the candidate PSCell; and
based on that a pair of a candidate PCell and a candidate PSCell related to the candidate PCell satisfying each execution condition for the conditional mobility does not exist:
performing the conditional mobility for a candidate PCell or a candidate PSCell which fulfills an execution condition.

15. The wireless device of claim 14,
wherein the pair of a candidate PCell and a candidate PSCell related to the candidate PCell satisfying each execution condition for the conditional mobility includes (i) a candidate PCell satisfying an execution condition for the candidate PCell and (ii) a PSCell related to the candidate PCell satisfying an execution condition for the candidate PSCell.

16. The wireless device of claim 14,
wherein the information related to conditional mobility for one or more candidate PCells and one or more candidate PSCells is included in a radio resource control (RRC) reconfiguration message.

17. The wireless device of claim 14,
wherein the information related to conditional mobility for one or more candidate PCells and one or more candidate PSCells includes (i) information related to one or more execution conditions for the one or more candidate PCells and (ii) information related to one or more execution conditions for the one or more candidate PSCells.

18. The wireless device of claim 14, wherein the operations further comprises:
evaluating a conditional reconfiguration related to the conditional mobility for one or more candidate PCells and one or more candidate PSCells.

19. The wireless device of claim 14, wherein the operations further comprises:
performing measurements for the one or more candidate PCells and the one or more candidate PSCells.

20-29. (canceled)

30. A base station in a wireless communication system comprising:
a transceiver;
a memory; and
a processor operatively coupled to the transceiver and the memory, and adapted to:
transmit, to a wireless device, information related to conditional mobility for one or more candidate Primary Cells (PCells) and one or more candidate Primary SCG Cells (PSCells);
wherein, based on that a pair of a candidate PCell and a candidate PSCell related to the candidate PCell satisfying each execution condition for the conditional mobility exists, the wireless device performs the conditional mobility for the candidate PCell and the candidate PSCell, or
wherein, based on that a pair of a candidate PCell and a candidate PSCell related to the candidate PCell satisfying each execution condition for the conditional mobility does not exist, the wireless device performs the conditional mobility for a candidate PCell or a candidate PSCell which fulfills an execution condition.
